(19) United States
(12) Patent Application Publication
(10) Pub. No.: US 2023/0128905 A1
(43) Pub. Date: Apr. 27, 2023

(54) Method of Preparing a Packaging Box

(71) Applicant: AGFA NV, Mortsel (BE)

(72) Inventors: Sam Verbrugghe, Mortsel (BE); Quentin Van Den Hove D?Ertsenryck, Mortsel (BE)

(73) Assignee: AGFA NV, Mortsel (BE)

(21) Appl. No.: 17/910,393

(22) PCT Filed: Oct. 23, 2020
(86) PCT No.: PCT/EP2020/079889

§ 371 Date: Sep. 9, 2022

(30) Foreign Application Priority Data
Mar. 12, 2020 (EP) 20162582.9

(51) Int. Cl. B65B 61/26; B65B 5/02; B65B 59/00; B41J 3/28

(52) U.S. Cl. CPC B65B 61/26; B65B 5/024; B65B 59/001; B41J 3/286; B65B 2210/04

(57) ABSTRACT

A method of preparing a packaging box (50) wherein late stage customization (20) is provided on the inside of the packaging box. Late stage customization is provided on a folded packaging box. Late stage customization is provided by an imaging technique selected from laser marking, laser engraving, thermal printing and inkjet printing. The packaging box includes an image-receiving layer adapted to the imaging-technique.

### TECHNICAL FIELD OF THE INVENTION

The present invention relates to a method of preparing packaging boxes in an e-commerce environment.

### BACKGROUND ART FOR THE INVENTION

The role of e-commerce is becoming more and more significant in retail. Customers are increasingly placing orders online from the comfort of their homes via a website. The ordered merchandise is then put into a packaging box, referred to herein as an e-box, and delivered to the customer's residence or another desired address. In this manner a customer can conveniently make a purchase without having to devote time and effort to physically travel to a store to look for the desired merchandise, if available.

In e-commerce, the process of picking the ordered products and packing these products in a suitable packaging box (e-box) is typically referred to as fulfilment.

With the role of e-commerce becoming more and more significant, the direct contact of the seller with the customer decreases. Companies are investigating ways to maintain and enhance customer experience and customer engagement in an e-commerce environment. An e-box is one of the important touchpoints between a customer and the seller. For that reason, the e-box becomes more and more significant to enhance the customer experience and engagement. Communication with a customer when receiving and opening the e-box is referred to as the unboxing experience. The unboxing experience may be enhanced by providing customized or even personalized messaging on the e-box. Such customized and/or personalized messaging is preferably provided as late as possible in the packaging process and is therefore referred to herein as late stage customization of the packaging box.

U.S. Ser. No. 10/011,377 (AMAZON TECH INC) disclose a method of preparing a shipment container wherein information similar to retail packaging is provided on the inside surfaces of the shipment container while customized information is provided on the exterior surfaces.

Also, merchandise articles come in different dimensions. Therefore e-boxes having different sizes are used. For this reason, a packer typically has a stock of unfolded e-boxes in different sizes. Even with a large variety in predetermined dimensions of e-boxes, significant free space generally remains in the packaging box containing one or more merchandise articles. This free space, frequently filled up with a cheap filler material, results in inefficient shipping as fewer packaging boxes can be loaded into a delivery vehicle.

EP3354581 (NEOPOST TECH) disclose a method of preparing an e-box wherein the dimension of a customized cardboard box is calculated based on the dimensions of the articles to be packed.

There remains a need for an approach in which e-commerce companies can deliver packages in a more efficient and economical way, while at the same time having the option to enhance customer experience and customer engagement.

### SUMMARY OF THE INVENTION

It is an object of the present invention to provide a method of preparing a packaging box resulting in an enhancement of the unboxing experience for the customer.

It was found that providing late stage customization on the inside of the packaging box just before, during or after filling the packaging box with one or more purchased articles results in an efficient process while enhancing customer experience and customer engagement.

These and other objectives will become apparent from the description hereinafter.

### BRIEF DESCRIPTION OF DRAWINGS

FIG. 1 schematically depicts an embodiment of a method of preparing a packaging box (50) according to the present invention wherein late stage customization is provided on both the inside (20) and the outside (30) of a packaging box.

FIG. 2 schematically illustrate the unboxing experience wherein a packaging box prepared according to the present invention is opened by a customer.

FIG. 3 schematically depicts a first embodiment of the method of preparing a packaging box wherein late stage customization is provided on an unfolded packaging box.

FIG. 4 schematically depicts a partial sealed unfolded packaging box.

FIG. 5 schematically depicts a second embodiment of the manufacturing method of an e-box wherein late stage customization is provided on a folded packaging box.

FIG. 6 illustrates the composition of a packaging material suitable for the invention formed by gluing a paper fluting medium 510 with glue 520 to a paper inner liner 530 and a paper outer liner 500.

### DETAILED DESCRIPTION OF THE INVENTION

### Definitions

Unless otherwise specified the term “alkyl” means all variants possible for each number of carbon atoms in the alkyl group i.e. methyl, ethyl, for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethyl-propyl and 2-methyl-butyl, etc.

Unless otherwise specified a substituted or unsubstituted alkyl group is preferably a C₁ to C₆-alkyl group.

Unless otherwise specified a substituted or unsubstituted alkenyl group is preferably a C₂ to C₆-alkenyl group.

Unless otherwise specified a substituted or unsubstituted alkynyl group is preferably a C₂ to C₆-alkynyl group.

Unless otherwise specified a substituted or unsubstituted aralkyl group is preferably a phenyl or naphthyl group including one, two, three or more C₁ to C₆-alkyl groups.

Unless otherwise specified a substituted or unsubstituted alkaryl group is preferably a C₇ to C₂₀-alkyl group including a phenyl group or naphthyl group.

Unless otherwise specified a substituted or unsubstituted aryl group is preferably a phenyl group or naphthyl group

Unless otherwise specified a substituted or unsubstituted heteroaryl group is preferably a five- or six-membered ring substituted by one, two or three oxygen atoms, nitrogen atoms, sulphur atoms, selenium atoms or combinations thereof.

The term “substituted”, in e.g. substituted alkyl group means that the alkyl group may be substituted by other atoms than the atoms normally present in such a group, i.e. carbon and hydrogen. For example, a substituted alkyl group may include a halogen atom or a thiol group. An unsubstituted alkyl group contains only carbon and hydrogen atoms

Unless otherwise specified a substituted alkyl group, a substituted alkenyl group, a substituted alkynyl group, a substituted aralkyl group, a substituted alkaryl group, a substituted aryl and a substituted heteroaryl group are preferably substituted by one or more constituents selected from the group consisting of methyl, ethyl, n-propyl, isopropyl, n-butyl, isobutyl and tertiary-butyl, ester, amide, ether, thioether, ketone, aldehyde, sulfoxide, sulfone, sulfonate ester, sulfonamide, —Cl, —Br, —I, —OH, —SH, —CN and —NO₂.

### Method of Preparing a Packaging Box

The method of preparing a packaging box according to the present invention is typically carried out by a so-called packer (see below) by providing a packaging box (10) (e-box) for one or more on-line purchased articles with so-called late stage customization on the inside of the packaging box (20).

There are several advantages when providing late stage customization on the inside of a packaging box, such as for example:
During transport of a packaging box to a customer the exterior of the packaging box is typically provided with several adhesive labels, such as for example a shipment label. When such labels are provided on top of customized or personalized messaging provided on the outside of the packaging box, such messaging may lose its attractiveness and/or meaning for the customer.
During transport of a packaging box the exterior of the packaging box may become damaged, again negatively influencing the appearance of customized or personalized messaging on the outside of the box.
Providing information on the outside of the box increases the chances of theft because the content may be revealed from the outside print. Thus, providing information on the inside of a packaging box may reduce the chances of theft because people may be less likely to steal a package, which does not reveal its content.
A customer may prefer that there are no indications on the content of the packaging box or other personal information on the outside of a packaging box for privacy purposes.

Late stage customization is preferably provided on the inside of a top flap of the packaging box. A packaging typically contains one or more top flaps that are used to close the packaging box after filling it with the purchased articles. When the customer receives the packaging box at home, opening the box will reveal the late stage customization and realize the unboxing experience.

This is illustrated in FIG. 2 for a so-called American folding box, also known as fefco 0210 box. A customer receives a closed packaging box (150) at home. The packaging box contains a shipment label (160) at the outside of the box. The customer then opens the top flaps of the packaging box (175) to reveal its content. As late stage customization is provided on the inside of a top flap (140), opening the box will reveal it and draw the attention of the customer, thereby realizing an improved unboxing experience.

Late stage customization as used herein is provided as late as possible in the packaging process. The latest stage for customization of the packaging box is just before, during or after filling the e-box with the purchased products.

The time between providing late stage customization and filling the packaging box with the one or more purchased articles is preferably less than 1 day, more preferably less than 12 hour, most preferably less than 1 hour. However, to speed up the packaging process, the time may be less than 15 minutes, more preferably less than 5 minutes, most preferably less than 1 minute.

The time wherein late stage customization is provided on the packaging box is preferably less than 120 seconds, more preferably less than 60 seconds, most preferably less than 10 seconds.

Preferably, each packaging box manufactured according to the method of the present invention is unique because the late stage customization, dependent on the order, the customer, the timing, etc. is different for each packaging box.

A packaging box may also be referred to as a shipment container.

Late stage customization is preferably provided by an imaging technique selected from the group consisting of laser marking, laser engraving, thermal printing, inkjet printing and electrophotography, more preferably selected from the group consisting of laser marking, laser engraving, thermal printing and inkjet printing, most preferably selected from the group consisting of laser marking and inkjet printing.

The packaging box preferably comprises, at least partially, an image-receiving layer adapted to the imaging technique used to provide the late stage customization.

The packaging box is preferably a cardboard box.

Typically, a brand owner, an e-retailer, a distribution centre, a fulfilment centre or an external logistics company, all referred to herein as a packer, uses optionally pre-printed unfolded packaging boxes of varying size to prepare a packaging box wherein one or more on-line purchased articles will be packed.

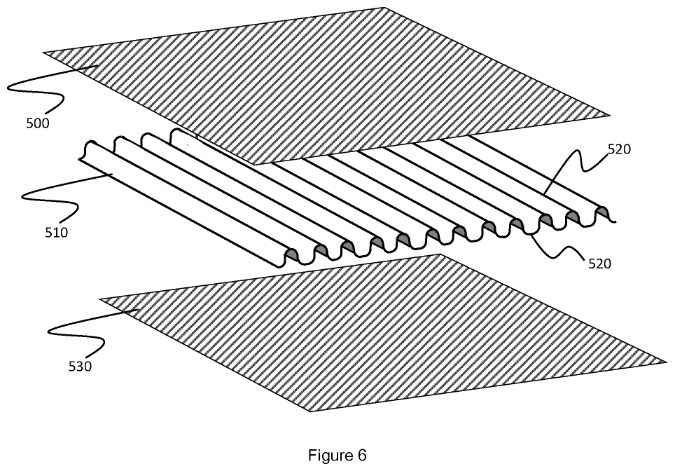

As disclosed below in more detail, an unfolded packaging box referred to may be a single sheet cutted and creased cardboard as illustrated in FIG. 3 (200) or a partially sealed cutted and creased cardboard as illustrated in FIG. 5 (430).

Pre-printing of the unfolded boxes is typically carried out by the supplier of the unfolded boxes. Pre-printing is typically carried out on a single sheet, flat cardboard, thus before partially sealing it as described above. The pre-printed information is typically invariable information, for example the logo of the online seller or the packer. The invariable information is typically printed on the unfolded box by printing techniques such as flexographic printing, offset printing, gravure printing, inkjet printing, valve jet printing or xerography.

The image-receiving layer referred to above is preferably provided, optionally together with the invariable information, on the unfolded packaging box. The same printing techniques mentioned above or alternatively traditional coating methodologies may be used to apply the image-receiving layer. Preferably, the image-receiving layer and the invariable information are provided on the unfolded boxes with the same printing technique.

The image-receiving layer is preferably provided on one or more parts of the unfolded packaging box that will form the inside of the folded packaging box.

The size of the invariable information and the image-receiving layer and their position on the packaging box are preferably adapted to the size of the packaging box.

Optionally pre-printed unfolded packaging boxes, preferably also comprising the imaging-receiving layer, of varying sizes may then be delivered to the packer for fulfilment of orders. However, the optionally pre-printed unfolded packaging boxes, preferably also comprising the image-receiving layer, may also be prepared by the packer.

The packer may then select an unfolded packaging box depending on the size of the one or more purchased articles to be packed. The packer preferably selects the size of the unfolded packaging box based on the outer dimension of the one or more purchased articles as described below.

Late stage customization may be provided on an unfolded or a folded packaging box.

According to a preferred embodiment of the invention, the method of manufacturing a packaging box includes the steps of:
selecting an unfolded packaging box (200);
providing late stage customization on at least a part of the unfolded packaging box that will form the inside of a packaging box (215);
folding the unfolded packaging box provided with the late stage customization to obtain a packaging box (250);
filling the packaging box with one or more purchased articles; and
closing the filled packaging box.

The method is illustrated in FIG. 3 for a so-called postal box (FEFCO 0427).

The unfolded packaging box (200) may be first folded before providing the late stage customization, but it is preferred to provide late stage customization on the unfolded box. Providing late stage customization with an imaging techniques described below, for example inkjet printing, may be less complex when it can be carried out on the unfolded packaging box.

Also, using an unfolded packaging box (200) enables late stage customization to be provided on at least a part of the unfolded packaging box that will form the inside and on at least a part that will form the outside of the folded packaging box (recto-verso imaging). For example, late stage customization for improving the unboxing experience is preferably applied on those parts of the unfolded packaging box that will form the inside of the packaging box while shipment information, which is typically applied on a label and attached to the outside of the box, is preferably provided on those parts that will form the outside of the packaging box. Providing such shipment information directly on the outside of the packaging instead of using a label has several advantages such as no damaged or detached labels, no stock of labels necessary.

The shape of the unfolded packing box (200) may vary depending on the type of packaging box.

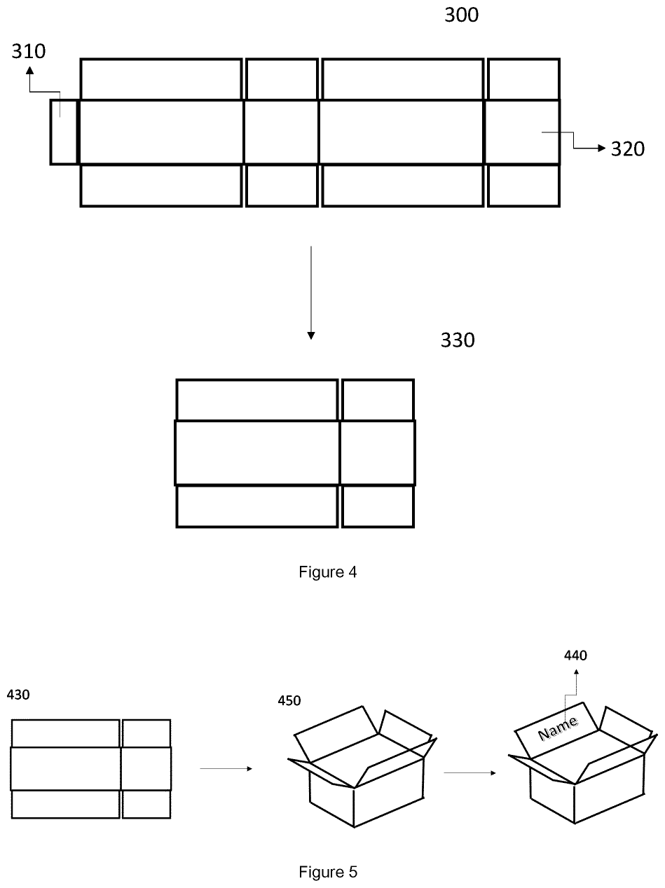

However, most of the times the unfolded packaging boxes of varying size available at the packer are partially sealed together as depicted in FIG. 4.

Flap (310) of a single sheet of cutted and creased cardboard (300) is sealed to flap (320) of the same sheet thereby forming the partially sealed unfolded packaging box (330).

Typically, such a partially sealed unfolded packaging box (330) is delivered to a packer.

Folding such a partially sealed unfolded packaging box (330) and filling it with the purchased articles is less complex and takes much less time compared with a situation wherein the packer has to start from the single sheet of cutted and creased cardboard (300).

When starting from such a partially sealed unfolded packaging box (330), providing late stage customization on the inside of the packaging box is only possible on the folded packaging box.

For example, the so-called American folding box, also known as FEFCO 0210 box, which is the most used packaging box in e-commerce, is typically delivered to a packer as a partially sealed unfolded packaging box. Providing late stage customization on the inside of such an American folding box is only possible after folding the box (see FIG. 5).

Therefore, according to another preferred embodiment of the invention, the method of manufacturing a packaging box includes the steps of:
selecting an unfolded packaging box (430);
folding the selected unfolded packaging box to obtain a packaging box (450);
providing late stage customization information on the inside of the packaging box (440) before, during or filling the packaging box with one or more articles; and
closing the filled packaging box.

The unfolded packaging box (430) referred to in this embodiment is preferably a partially sealed unfolded packaging box.

Late stage customization is preferably provided after filling the packaging box with the one or more purchased articles.

Late stage customization as used herein are is an assembly of variable data to be provided on the packaging box. As described below, late stage customization may include graphical and/or textual information.

Late stage customization is preferably adapted to the size of the e-box, for example the size of the late stage customization and its location on the e-box. Such graphical and textual information may be independently from each other optimized to the size of the e-box.

The content of late stage customization is prepared based on the information available when the purchased articles are packed. Such information is for example based on information available from the customer, the seller or the timing when the articles are packed, as described below in more detail. Also, as already mentioned, the size of the late stage customization is based on the dimension of the packaging box that will be used. All that information is assembled and used to design the late stage customization to be provided on the inside of the packaging box.

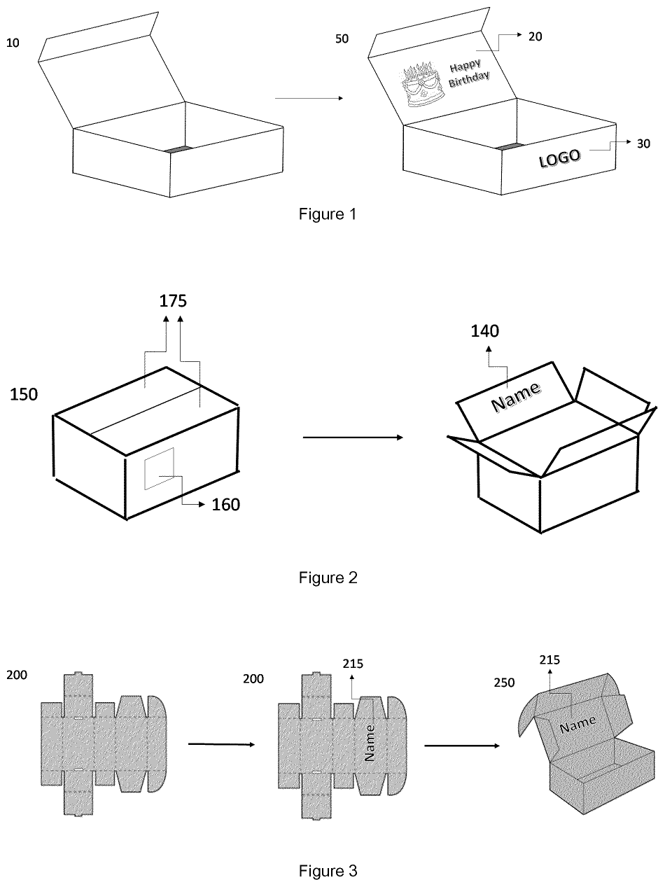

Late stage customization is preferably provided on the one or more top flaps of the e-box, as shown in FIGS. 1, 2, 3 and 5. When a customer opens the e-box the late stage customization becomes visible and will attract the attention of the customer.

A packaging box may comprise one or more top flaps. For example an American folding box (FIG. 5) typically comprises four top flaps. Late stage customization is preferably provided on the largest top flap of the packaging box.

To ensure that a customer will open the top flaps (and not the bottom flaps) an indication is preferably provided on the outside of the box to guide the customer to position the e-box before opening it in the right position.

In addition to providing late stage customization on the inside of the packaging box late stage customization may also be provided on the outside of the packaging box. The imaging technique for providing the late stage customization at the inside of the packaging box is preferably the same imaging technique for providing the late stage customization on the outside of the packaging box.

However, late stage customization at the outside of the packaging may also be provided on a label, which is then attached on the outside of the packaging box. Such a label is for example a shipment label.

A shipment label typically contains information on the place where the packaging box has to be delivered (postal code, address, etc.), a tracking number, information on the content or information on the method of shipping, visible and invisible 1 D and 2D barcodes, etc.

The closing of the packaging box may be manual using a handhold packing gun or may be automated on a conveyer belt using an automatic case sealer. The latter allows the filled boxes to remain open for printing the inside using a print module on the conveyer belt.

In a preferred embodiment a packaging box containing the one or more purchased articles is provided on a conveyer belt where it is provided with late stage customization using a “print” module and subsequently closed with an automatic case sealer. The “print” module referred to may include one or more lasers when the imaging technique used is laser marking or laser engraving or one or more print heads in case the imaging technique is inkjet printing or thermal printing.

Instead of selecting from pre-sized unfolded packaging boxes, each unfolded packaging box maybe made according to the minimal packaging box dimensions of the purchased articles. The unfolded packaging box may then be cutted and creased according to the minimal packaging box dimensions. In this embodiment, the invariable information and the image-receiving layer is preferably provided according to the minimal packaging box dimensions. If the packer does not cut and crease the packaging box himself, he may pass along to the supplier of the unfolded packaging boxes the minimal packaging box dimensions. With this method, the size of each packaging box is adapted to the size of the purchased articles. In this way, the amount of cardboard to prepare the packaging box is minimized. Moreover, the space needed to transport the packaging box is also minimized.

### Late Stage Customization

The manufacturing method according to the present invention improves the unboxing experience.

The unboxing experience is preferably realized by personalized messages and/or advertisements.

The late stage customization preferably includes advertisement for products related to the purchased product. Such related products may be accessories suitable for the ordered merchandise articles, for example earphones for an ordered smartphone.

As the online seller is in the possession of a lot of individual information of the customer, that information may be used for such personalized messages and/or images. That information may be extracted from the interaction of the customer on the website of the online seller. For example, from the browser history of the customer it can be derived in which products that customer is interested in addition to the product the customer effectively ordered online. On the e-box, wherein the ordered products are delivered, advertisements for such other products may be added. For example, discounts for such other products may be announced for that customer.

Also, a lot of personal information of the customer is available to the online seller, for example the birthday. When an e-box will be delivered on the birthday of that customer, a happy birthday image/message may be added on the e-box. Such a message may include discounts for other products or credits for further online ordering.

Also, the customized information may be dependent on the date of shipment of the articles to the customer. For example, a packaging box to be shipped around Christmas may contain a Merry Christmas message.

A physical retail shop often provides customer fidelity cards upon sale of merchandise, in order to promote future sale of similar or other merchandise articles at a reduced price. A similar system is today set up by the e-commerce company to offer a discount on a future order of the customer by sending an e-mail to the customer. However, this e-mail is often simply deleted or ended up in the spam-folder. By providing such discounts for future purchase orders on the e-box, a larger sales effect may be expected, as the customer is often more excited and enthusiastic upon opening the just received packaging box than upon opening an e-mail.

The image provided on the e-box is preferably part of a so-called omnichannel retail wherein different channels are used to enhance the customer experience. The image may for example contain incitements for the customer to visit the physical retail shop. Or, the image may also contain a machine readable code, such as a QR-code, which after scanning by the smartphone of a customer leads to a website of the online marketplace or the brand owner for enhancing the customer experience.

There is no real limitation to the content of the late stage customization, herein referred to as the late stage customization image. It may contain decorative features, company logo's, trademarks, photographs, drawings and cartoons and/or information. The information may be human readable, such as text, or it may be machine readable, such as a bar code, or a combination of both.

Late stage customization maybe include single coloured or multi-coloured images.

Multi-coloured images may comprise two or more different colours. The multi-coloured images may be so-called full colour images using CMYK or RGB images.

Late stage customization may also include grey scale images, for example 8-bit mono- and full colour images. As laser marking is a continuous tone (contone) imaging technique, the colour density in an image can be varied quasi-continuously by changing the laser power.

The image preferably contains one or more machine readable codes.

There is no restriction on the type of machine readable code or the information it contains. It may be a simple bar code, but it may also be a so-called 2D code. Preferred 2D codes include a QR code, a Datamatrix code, a cool-data-matrix code, an Aztec code, an Upcode, a trillcode, a quickmark code, a shot code, an M-code, and a BeeTagg code.

The information present in the machine code may be the required information or it may be a link for retrieving the information from a source, such as a database or the internet.

The image preferably include a digital fingerprint code as disclosed in EP3120293 (AGFA) and/or a Digimarc® barcode. Both machine-readable codes, generally imperceptible to the human eye, enables identification of the packaged products with for example phones, barcode scanners, cameras, fixed-mount barcode readers and other computer interfaces.

According to another preferred embodiment, the image preferably includes a 2D barcode as disclosed in EP-A 3252680 (Agfa). By scanning the 2D barcode with for example a mobile device the authenticity of the product may be verified.

The image may also include known security features such as guilloches or microprints.

By providing this or other information directly on the packaging box, multiple issues are solved which occur with adhesive labels, such as a package with a missing label or a mislabeled package. Using labels also means extra materials, which makes the process more expensive and environmentally harmful, and extra logistic issues. Problems with damaged or unreadable labels can be solved by providing the information, e.g. a machine readable code, multiple times on different outer surfaces of the packaging box.

### Laser Marking

In a laser marking step, late stage customization is provided on the inside of the packaging box by means of a laser, preferably an infrared (IR) laser, more preferably a near infrared (NIR) laser.

A laser marked image is a result of a colour change of the packaging material or the image-receiving layer provided on the packaging material upon exposure with the laser.

Advantages of laser marking, also referred to as photonic printing, compared to other variable printing techniques is the absence of chemicals during laser marking (i.e. in the packaging line at the packer), the possibility to laser mark 3D objects and/or irregular surfaces and speed. The latter being very important for providing late stage customization in a packaging line at a packer.

In principle any laser may be used in the laser marking step. Preferred lasers are ultraviolet (UV) and infrared (IR) lasers, infrared laser being particularly preferred.

The infrared laser may be a continuous wave or a pulsed laser.

For example a CO₂ laser, a continuous wave, high power infrared laser having an emission wavelength of typically 10600 nm (10.6 micrometer) may be used.

CO₂ lasers are widely available and cheap. A disadvantage however of such a CO₂ laser is the rather long emission wavelength, limiting the resolution of the laser marked information.

To produce high resolution laser marked data, it is preferred to use a near infrared (NIR) laser having an emission wavelength between 780 and 2500, preferably between 800 and 1500 nm in the laser marking step.

A particularly preferred NIR laser is an optical pumped semiconductor laser. Optically pumped semiconductor lasers have the advantage of unique wavelength flexibility, different from any other solid-state based laser. The output wavelength can be set anywhere between about 920 nm and about 1150 nm. This allows a perfect match between the laser emission wavelength and the absorption maximum of an optothermal converting agent present in the laser markable layer.

A preferred pulsed laser is a solid state Q-switched laser. Q-switching is a technique by which a laser can be made to produce a pulsed output beam. The technique allows the production of light pulses with extremely high peak power, much higher than would be produced by the same laser if it were operating in a continuous wave (constant output) mode, Q-switching leads to much lower pulse repetition rates, much higher pulse energies, and much longer pulse durations.

One or more lasers may be used to laser mark.

When full colour images are laser marked, typically three different lasers are used, each having a different wavelength as described in EP-A 2722367 (Agfa Gevaert).

To produce multiple colours, multiple lasers are preferably used. For example, when a first and a second laser markable image-receiving layers capable of forming respectively a first and a second colour are used, a first and a second NIR laser each having a different emission wavelength are preferably used. The first NIR laser induces the first colour, the second NIR laser induces the second colour. To realize full colour late stage customization, typically three different image-receiving layers and three lasers, each having a different wavelength, are used as described in EP-A 2722367 (Agfa Gevaert).

For enhancing the speed of laser marking, a so-called laser array, for example a laser diode array, may be used. Using such multi-beam laser systems enables high speed laser marking at high resolutions.

High speed laser marking at high resolutions may also be realized with a so-called DMD (Digital Mirror Device).

Laser marking may also be carried out using a so-called Spatial Light Modulator (SLM) as disclosed in WO2012/044400 (Vardex Laser Solutions).

### Thermal Printing

In a thermal printing step, late stage customization is provided on the packaging box by means of thermal print heads.

In principle any type of thermal print head may be used. A thermal print head comprises heating elements. The heating elements convert electrical energy into heat through the process of Joule heating. Electric current through the element encounters resistance, resulting in heating of the element. The amount of electrical energy supplied to the heating elements can be varied by varying the amount of electric current within a particular time interval and/or varying the time interval during which electric current is supplied.

The number of heating elements of a print head determines the print resolution. Typical values are 200 to 300 heating elements (dots) per inch (dpi). However, thermal printers with a resolution of 400 and 600 dpi are also available.

Thermal printers and thermal printing methods are disclosed in for example US850287 (Zinc Imaging) and US2020/016904 (Canon).

### Laser Engraving

In a laser engraving step, late stage customization is provided on a packaging box by means of a laser. The laser engraved image is a result of a removal of material from the packaging box or from an image-receiving layer provided on the packaging box upon laser exposure. Laser engraving as used herein is also referred to as laser ablation.

Because material has to be removed, the laser used for laser engraving is typically a high energy laser, such as or example a CO₂ laser.

Preferably, a laser engraving module includes means to remove dust and/or debris formed during the laser engraving process.

### Inkjet Printing

Inkjet printing is well known as variable printing technique wherein an inkjet ink is jetted on a substrate by means of one or more printheads.

An advantage of using inkjet printing is the ability to realize full colour late stage customization including high quality and stable images.

Any type of inkjet printer such as a single pass or multi-pass inkjet printer may be used.

For printing on a single sheet, unfolded packaging box conventional inkjet printers may be used.

For printing on a folded packaging box, for example on the inside of a top flap, more dedicated print modules are preferably used.

### Determining Minimal Box Dimensions

The minimal packaging box dimensions are determined based on the outer dimensions of one or more merchandise articles to be packed into the packaging box.

The minimal packaging box dimension may be determined on a visual basis by the packer. For example, when a particular article has to be packed, the packer selects out of the available unfolded packaging boxes having different sizes an unfolded packaging box having a size enabling packing of the particular article.

The minimal packaging box dimension may also be determined by scanning the outer dimensions of a merchandise article or the outer dimensions of a compact arrangement of multiple merchandise articles. The compact arrangement is preferably optimized so that the packaging box dimensions are minimized.

However, in a more preferred embodiment the outer dimensions of the one or more merchandise articles have been determined previously and are digitally stored in a database of a computer server. When needed, the outer dimension of a merchandise article is retrieved from the database in order to determine minimal box dimensions. When multiple merchandise articles are to be packed into a single packaging box, then a computer first calculates what the minimal packaging dimensions are needed for an optimized compact arrangement of the multiple merchandise articles in the packaging box. The calculated minimal packaging box dimensions are then the minimal packaging box dimensions used in the method.

Preferably, the optimized compact arrangement of the multiple merchandise articles to be included in the packaging box is visualized by an image provided on the packaging material. The latter allows to gain time by the person arranging the merchandise articles in the assembled packaging box.

The minimal packaging box dimensions are determined by the one or more merchandise articles to be included into the packaging box. These merchandise articles are often themselves packed into a packaging having a rectangular cuboid shape. The length, width and height of this rectangular cuboid shape is used for determining the minimal packaging box dimensions. A few millimetres, e.g. 5 mm, are added to each of the length, width and height of this rectangular cuboid shape in order to obtain minimal packaging box dimensions. These extra millimeters allow for an easy entry of the merchandise article into the packaging box when making it ready for shipment.

The length, width and height of a rectangular cuboid shape can be measured with a ruler or tape measure. In order to gain efficiency, a scanning system may be used to accelerate the measurement of the length, width and height of a merchandise article. Or if multiple merchandise articles are to be included into the packaging box, the length, width and height of a compact arrangement of the multiple merchandise articles may be determined by scanning and the multiple merchandise articles are then subsequently included in the same arrangement into the packaging box.

In a particularly preferred embodiment, the outer dimensions for a certain merchandise article have been predetermined and are stored into a database of a computer server, where they can be retrieved when the merchandise article is ordered by a customer. This way the time-consuming process for repeatedly determining the minimal packaging box dimensions is avoided. In addition, when multiple merchandise articles are ordered, the computer server may even calculate an optimized arrangement of the multiple merchandise articles in the packaging box. An image of such an optimized arrangement of the multiple merchandise article may be provided on the packaging material for helping the shipping center to arrange the different merchandise articles into to the packaging box. This image may also help the customer to arrange the ordered merchandise articles into to the packaging box when he is dissatisfied and wants to return them.

Pre-determining the dimensions and storing them in a database is especially time-saving and efficient for merchandise articles having a shape different from a rectangular cuboid shape or even a totally irregular shape.

As described above, by determining the minimal packaging box dimensions the proper packaging box size may be selected out of a number of sizes available at the packer or may be used to prepare a packaging box having an optimal size as function of the purchased articles.

However, the minimal packaging box size may not only be depend on the size of the purchased articles but also on the size of the images that have to laser marked on the box. Especially for customized images, as described below, a minimum size of the image maybe necessary to include all the necessary information or for aesthetic reasons.

### Image-Receiving Layer

At least part of the packaging box is preferably provided with an image-receiving layer. The image-receiving layer is preferably provided on an unfolded packaging box. The image-receiving layer is preferably positioned on the unfolded packaging box in such a way that it will end up on the inside of the folded packaging box enabling late stage customization on the inside of the packaging box.

The image-receiving layers are preferably adapted to the print technique used for late stage customization as described below.

The image-receiving layer may be applied onto the packaging material by co-extrusion or any conventional coating technique, such as dip coating, knife coating, extrusion coating, spin coating, spray coating, slide hopper coating and curtain coating.

The image-receiving layer may also be applied onto the packaging material by any printing method such as intaglio printing, screen printing, flexographic printing, offset printing, inkjet printing, rotogravure printing, etc.

The image-receiving layer is preferably provided on the unfolded packing box together with the invariable information, such as for example a logo or an image. Preferably both the image-receiving layer and the fixed information is provided on the unfolded packaging box by the same printing technique such as flexographic printing.

A transparent image-receiving layer may be provided on top of invariable information. Is this way the resulting total image, for example inside the packaging box, is a combination of fixed and late stage customized information. For example a birthday cake may be printed as fixed information and covered with a transparent laser markable layer. The name of the customer may then be added late stage on the folded packaging box in a laser marking step.

The image-receiving layer may include one or more layers.

For example to realize multicolour images by thermal printing or laser marking, the image-receiving layer may include two, three or more layers, each layer capable of forming a different colour. Such image-receiving layers capable of forming multicolour images are disclosed in for example EP-A 2722367 (Agfa Gevaert) and WO2013/068729 (Datalase).

Another example is an image-receiving layer for laser engraving including two layers each having a different colour as described above.

Also, a protective coating may be provided on top of the image-receiving layer. The protective coating may provide the late stage image with a certain scratch resistance and can also provide a glossy finish to the image.

The protective coating may also comprise UV absorbers to improve the daylight stability of the image.

An advantage of laser marking and thermal printing compared to other digital “printing” techniques is the fact that such a protective coating may be applied before the imaging step.

The provision of the image-receiving layer preferably takes into account the minimal box dimensions referred to above.

### Image-Receiving Layer for Laser Marking

An image-receiving layer for laser marking is preferably prepared by applying a laser markable composition on an unfolded packaging box.

A laser markable composition typically comprises a colour forming agent. The colour forming agent is capable of forming a colour upon exposure with a laser.

Preferably, the laser markable composition includes an optothermal converting agent that is capable of converting radiation energy in to heat.

The laser markable compositions may be aqueous compositions or non-aqueous compositions. Both the aqueous and non-aqueous compositions may be radiation curable, preferably UV curable.

A preferred aqueous based composition includes encapsulated leuco dyes. Such aqueous compositions wherein the leuco dyes are encapsulated are disclosed in for example EP-A 3297837, EP-A 3470134 and EP-A 3470135, all from Agfa Gevaert. The aqueous based composition may be radiation curable, preferably UV curable. Such radiation curable aqueous composition are disclosed in EP-A 18196206.9 and EP-A 18196211.9 (both from Agfa Gevaert and filed on 24 Sep. 2018).

Non-aqueous laser markable compositions are disclosed in for example EP-A 3083261 (Agfa Gevaert). Preferred radiation curable non-aqueous laser markable compositions are disclosed in for example EP-A 19202712.6 (Agfa Gevaert filed on Nov. 10, 2019).

The radiation curable compositions typically include one or more polymerizable compounds and one or more photo-initiators.

The laser markable composition is preferably a flexographic or inkjet ink.

To optimize the coating or printing properties, and also depending on the application for which it is used, various additives may be added to the composition, such as surfactants, wetting/levelling agents, rheology modifiers, adhesion promoting compounds, biocides or antioxidants may be added to the laser markable composition.

### Colour Forming Agent

The laser markable composition comprises a colour forming agent, which is capable of forming a colour upon laser marking.

All known colour forming agents may be used.

A transition metal oxide, such as molybdenum trioxide, has been disclosed in WO2008/075101 (SILTECH).

An oxyanion of a multivalent metal, such as ammonium octyl molybdate, has been disclosed in WO2002/074548 (DATALASE) and WO2007/012578 (DATALASE).

These colour forming agents are capable of forming a black colour upon laser marking.

Diacetylene compounds, such as disclosed in WO2013/014436 (DATALASE) are capable of forming multiple colours.

Preferred colour formers are leuco dyes, as described below. A leuco dye is preferably used in combination with a developing agent.

Also, a combination of different colour forming agents may be used, for example to produce different colours. In WO2013/068729 (DATALASE), a combination of a diacetylene compound and a leuco dye is used to produce a full colour image upon exposure to UV and IR radiation.

### Leuco Dye

A leuco dye is a substantially colourless compound, which may form a coloured dye upon an inter- or intra-molecular reaction. The inter- or intra-molecular reaction may be triggered by heat, preferably heat formed during exposure with an IR laser.

Examples of leuco dyes are disclosed in WO2015/165854 (Agfa Gevaert), paragraph [069] to [093].

The laser markable composition may comprise more than one leuco dye. Using two, three or more leuco dyes may be necessary to realize a particular colour. Also, it has been observed that more stable dispersions may be obtained when two, three or more leuco dyes are used.

The amount of leuco dye in the laser markable layer is preferably in the range from 0.05 to 2 g/m², more preferably in the range from 0.1 to 1 g/m².

### Developing Agent

The radiation curable laser markable composition preferably comprises a developing agent.

A developing agent is capable of reacting with a colourless leuco dye resulting in the formation of a coloured dye upon laser marking. Typically, upon laser marking a compound is released that may react with a leuco dye thereby forming a coloured dye.

All publicly-known photo- or thermal acid generators can be used as developing agent. Thermal acid generators are for example widely used in conventional photoresist material. For more information see for example “Encyclopaedia of polymer science”, 4^{th} edition, Wiley or “Industrial Photoinitiators, A Technical Guide”, CRC Press 2010.

Preferred classes of photo- and thermal acid generators are iodonium salts, sulfonium salts, ferrocenium salts, sulfonyl oximes, halomethyl triazines, halomethylarylsulfone, α-haloacetophenones, sulfonate esters, t-butyl esters, allyl substituted phenols, t-butyl carbonates, sulfate esters, phosphate esters and phosphonate esters.

Particularly preferred developing agents have a structure according to Formula (I)

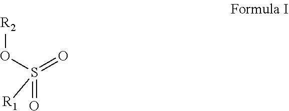

wherein

R1 represent an optionally substituted alkyl group, an optionally substituted (hetero)cyclic alkyl group, an optionally substituted alkanyl group, an optionally substituted alkenyl group, an optionally substituted alkynyl group, an optionally substituted (hetero)aryl group, an optionally substituted aralkyl group, an optionally substituted alkoxy group, an optionally substituted (hetero)cyclic alkoxy group, or an optionally substituted (hetero)aryl group.

R2 represent an optionally substituted alkyl, an optionally substituted aliphatic (hetero)cyclic alkyl group or an optionally substituted aralkyl group;

R1 and R2 may represent the necessary atoms to form a ring.

Such developing agents according to Formula I and their preparation are disclosed in WO2015/091688.

### Optothermal Converting Agent

An optothermal converting agent generates heat upon absorption of radiation.

The optothermal converting agent preferably generates heat upon absorption of infrared (IR) radiation, more preferably near infrared (NIR) radiation.

Near infrared radiation has a wavelength between 750 and 2500 nm.

Optothermal converting agents may be an infrared radiation absorbing dye but is preferably an infrared radiation absorbing pigment, or a combination thereof.

### Infrared Radiation Absorbing Inorganic Pigments

A preferred inorganic infrared absorber is a copper salt as disclosed in WO2005/068207 (DATALASE).

Another preferred inorganic infrared absorber is a non-stoichiometric metal salt, such as reduced indium tin oxide as disclosed in WO2007/141522 (DATALASE).

Particular preferred inorganic infrared absorbers are tungsten oxide or tungstate as disclosed in WO2009/059900 (DATALASE) and WO2015/015200 (DATALASE). A lower absorption in the visible region while having a sufficient absorption in the near infrared region is an advantage of these tungsten oxide or tungstate.

### Carbon Black

Another preferred infrared radiation absorbing pigment (IR pigment) is carbon black, such as acetylene black, channel black, furnace black, lamp black, and thermal black.

Due to its light absorption in the visible region, i.e. between 400 nm and 700 nm, a too high amount of carbon black may result in an increase of the background colour of the layer comprising the carbon black.

For that reason, the amount of carbon black in the laser markable layer is preferably less than 0.1 g/m2, more preferably less than 0.01 g/m2, most preferably less than 0.005 g/m2.

### Infrared Radiation Absorbing Dyes

An advantage of Infrared absorbing dyes (IR dyes) compared to IR pigments is their narrow absorption spectrum resulting in less absorption in the visible region. This may be of importance for the processing of transparent resin based articles where optical appearance is of importance.

A narrow absorption band is also mandatory for multicolour laser marking using multiple laser each having a different emission wavelength, as disclosed in for example EP-A 3297838.

Any IR dye may be used, for example the IR dyes disclosed in “Near-Infrared Dyes for High Technology Applications” (ISBN 978-0-7923-5101-6).

Preferred IR dyes are polymethine dyes due to their low absorption in the visible region and their selectivity, i.e. narrow absorption peak in the infrared region. Particular preferred polymethine IR dyes are cyanine IR dyes.

Preferred IR dyes having an absorption maximum of more than 1100 nm are those disclosed in EP-A 2722367, paragraphs [0044] to [0083] and WO2015/165854, paragraphs [0040] to [0051].

IR dyes having an absorption maximum between 1000 nm and 1100 nm are preferably selected from the group consisting of quinoline dyes, indolenine dyes, especially a benzo[cd]indoline dye. A particularly preferred IR dye is 5-[2,5-bis[2-[1-(1-methylbutyl)-benz[cd]indol-2(1H)-ylidene]ethylidene]-cyclopentylidene]-1-butyl-3-(2-methoxy-1-methylethyl)-2,4,6(1H,3H,5H)-pyrimidinetrione (CASRN 223717-84-8) represented by the Formula IR-1, or the IR dye represented by Formula IR-2:

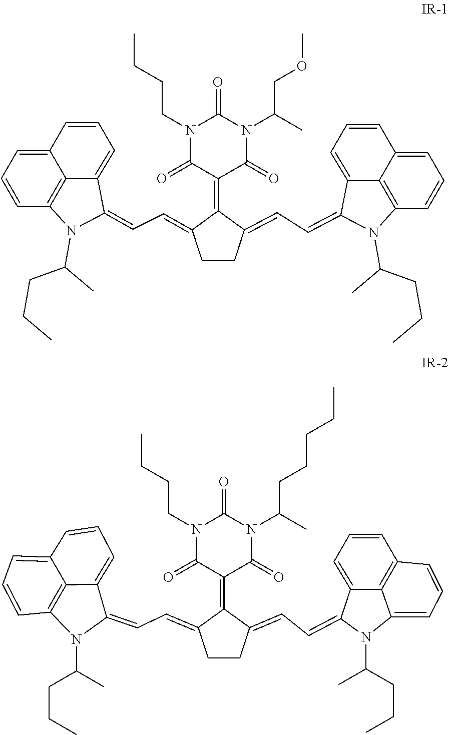 [SMILES: CCCCN1C(=O)/C(=C2C(=C/C=c3\c4cccc5cccc(c54)n3C(C)CCC)\CCC\2=C/C=c2\c3cccc4cccc(c43)n2C(C)CCC)C(=O)N(C(C)COC)C1=O ; CCCCCC(C)N1C(=O)/C(=C2C(=C\C=c3/c4cccc5cccc(c54)n3C(C)CCC)/CCC/2=C\C=c2/c3cccc4cccc(c43)n2C(C)CCC)C(=O)N(CCCC)C1=O]

Both IR dyes IR-1 and IR-2 have an absorption maximum λmax around 1052 nm making them very suitable for a Nd-YAG laser having an emission wavelength of 1064 nm.

Other preferred NIR absorbing compounds are those disclosed in WO2019/007833, paragraph [0034] to [0046]. It has been observed that these NIR absorbing compounds are more stable compared to for example those disclosed in WO2015/165854.

A combination of different optothermal converting agents may also be used.

The amount of optothermal converting agent is preferably at least 10⁻¹⁰ g/m², more preferably between 0.0001 and 0.5 g/m², most preferably between 0.0005 and 0.1 g/m².

### Polymerizable Compound

The laser markable composition including the color forming agent and/or the composition including the optothermal converting agent may be radiation curable compositions, preferably UV curable compositions.

Such radiation curable compositions comprise a polymerizable compound.

The polymerizable compounds may be monomers, oligomers or prepolymers.

The polymerizable compounds may be free radical polymerizable compounds or cationic polymerizable compounds.

Cationic polymerization is superior in effectiveness due to lack of inhibition of the polymerization by oxygen, however it is expensive and slow, especially under conditions of high relative humidity. If cationic polymerization is used, it is preferred to use an epoxy compound together with an oxetane compound to increase the rate of polymerization.

Preferred monomers and oligomers are those listed in paragraphs [0103] to [0126] of EP-A 1911814.

Radical polymerization is the preferred polymerization process. Preferred free radical polymerizable compounds include at least one acrylate or methacrylate group as polymerizable group, referred to herein as (meth)acrylate monomers, oligomers or prepolymers. Due to their higher reactivity, particularly preferred polymerizable compounds are acrylate monomers, oligomers or prepolymers.

Other preferred (meth)acrylate monomers, oligomers or prepolymers are N-vinylamides, such as N-vinylcaprolactam and acryloylmorpholine.

Particular preferred (meth)acrylate monomers, oligomers or prepolymers are selected from the group consisting of tricyclodecanedimethanol diacrylate (TCDDMDA), isobornyl acrylate (IBOA), dipropylene glycol diacrylate (DPGDA), ethoxylated [4] bisphenol diacrylate and urethane acrylate.

### Photoinitiator

The radiation curable laser markable composition preferably contains a photoinitiator. The initiator typically initiates the polymerization reaction. The photoinitiator may be a Norrish type I initiator, a Norrish type II initiator or a photo-acid generator, but is preferably a Norrish type I initiator, a Norrish type II initiator or a combination thereof.

A preferred Norrish type I-initiator is selected from the group consisting of benzoinethers, benzil ketals, α,α-dialkoxyacetophenones, α-hydroxyalkylphenones, α-aminoalkylphenones, acylphosphine oxides, acylphosphine sulphides, α-haloketones, α-halosulfones and α-halophenylglyoxalates.

A preferred Norrish type II-initiator is selected from the group consisting of benzophenones, thioxanthones, 1,2-diketones and anthraquinones.

Suitable photo-initiators are disclosed in CRIVELLO, J. V., et al. VOLUME III: Photoinitiators for Free Radical Cationic & Anionic Photopolymerization. 2nd edition. Edited by BRADLEY, G. London, UK: John Wiley and Sons Ltd, 1998. p. 287-294.

A preferred amount of photoinitiator is 0.3-20 wt % of the total weight of the radiation curable composition, more preferably 1-15 wt % of the total weight of the radiation curable composition.

In order to increase the photosensitivity further, the radiation curable composition may additionally contain co-initiators.

A preferred co-initiator is selected from the group consisting of an aliphatic amine, an aromatic amine and a thiol. Tertiary amines, heterocyclic thiols and 4-dialkylamino-benzoic acid are particularly preferred as co-initiator.

The most preferred co-initiators are aminobenzoates for reason of shelf-life stability of the radiation curable composition.

A preferred amount of photoinitiator is 0.3-20 wt % of the total weight of the radiation curable composition, more preferably 1-15 wt % of the total weight of the radiation curable composition.

The amount of co-initiator or co-initiators is preferably from 0.1 to 20.0 wt %, more preferably from 1.0 to 10.0 wt %, based in each case on the total weight of the radiation curable composition.

### Polymerization Inhibitors

For improving the shelf-life, the radiation curable laser markable composition may contain a polymerization inhibitor. Suitable polymerization inhibitors include phenol type antioxidants, hindered amine light stabilizers, phosphor type antioxidants, hydroquinone monomethyl ether commonly used in (meth)acrylate monomers, and hydroquinone, t-butylcatechol, pyrogallol may also be used.

Suitable commercial inhibitors are, for example, Sumilizer™ GA-80, Sumilizer™ GM and Sumilizer™ GS produced by Sumitomo Chemical Co. Ltd.; Genorad™ 16, Genorad™ 18 and Genorad™ 20 from Rahn AG; Irgastab™ UV10 and Irgastab™ UV22, Tinuvin™ 460 and CGS20 from Ciba Specialty Chemicals; Floorstab™ UV range (UV-1, UV-2, UV-5 and UV-8) from Kromachem Ltd, Additol™ S range (S100, S110, S120 and S130) from Cytec Surface Specialties.

Since excessive addition of these polymerization inhibitors will lower the sensitivity to curing, it is preferred that the amount capable of preventing polymerization is determined prior to blending. The amount of a polymerization inhibitor is preferably lower than 2 wt % of the total radiation curable laser markable composition.

### Surfactant

The radiation curable laser markable composition may contain at least one surfactant. The surfactant(s) can be anionic, cationic, non-ionic, or zwitter-ionic and are usually added in a total quantity less than 5 wt % based on the total weight of the inkjet ink and particularly in a total less than 2 wt % based on the total weight of the composition.

The radiation curable laser markable composition preferably have a surface tension between 18.0 and 45.0 mN/m at 25° C., more preferably between a surface tension between 21.0 and 39.0 mN/m at 25° C.

Preferred surfactants are selected from fluoro surfactants (such as fluorinated hydrocarbons) and/or silicone surfactants.

The silicone surfactants are preferably siloxanes and can be alkoxylated, polyester modified, polyether modified, polyether modified hydroxy functional, amine modified, epoxy modified and other modifications or combinations thereof. Preferred siloxanes are polymeric, for example polydimethylsiloxanes. Preferred commercial silicone surfactants include BYK™ 333 and BYK™ UV3510 from BYK Chemie.

Silicone surfactants are often preferred in radiation curable laser markable composition, especially the reactive silicone surfactants, which are able to be polymerized together with the polymerizable compounds during the curing step.

Examples of useful commercial silicone surfactants are those supplied by BYK CHEMIE GMBH (including Byk™-302, 307, 310, 331, 333, 341, 345, 346, 347, 348, UV3500, UV3510 and UV3530), those supplied by TEGO CHEMIE SERVICE (including Tego Rad™ 2100, 2200N, 2250, 2300, 2500, 2600 and 2700), Ebecryl™ 1360 a polysilixone hexaacrylate from CYTEC INDUSTRIES BV and Efka™_3000 series (including Efka™-3232 and Efka™-3883) from EFKA CHEMICALS B.V.

### Inorganic Nanofiller

The laser markable composition preferably comprises at least 1 wt % of an inorganic filler, relative to the total weight of the composition.

Examples of inorganic fillers that may be used are selected from the group consisting of calcium carbonate, clays, alumina trihydrate, talc, mica, and calcium sulphate.

Preferably, an inorganic nanofiller is used to obtain optimal transparency of the laser markable composition. A preferred nanofiller is nanosilica.

Nanosilica as referred to herein consist of amorphous silicon dioxide particles having a nano-particle size.

To obtain optimal transparency of the laser markable composition the particle size of the nanosilica is preferably in the range from 5 to 250 nm, more preferably in the range from 7.5 to 100 nm, most preferably in the range from 10 to 50 nm.

Preferably dispersions of nanosilica in acrylate monomers are used. Such commercially available dispersions are for example the Nanocryl® nanosilica dispersions available from Evonik.

The amount of the inorganic filler is preferably in the range from 1 to 15 wt %, more preferably in the range from 2 to 10 wt %, most preferably in the range from 2.5 and 7.5 wt %, all relative to the total weight of the composition.

After printing the composition on a support, the amount of the inorganic filler is preferably in the range from 0.1 to 1.5 g/m2, more preferably in the range from 0.2 to 1 g/m2, most preferably in the range from 0.25 to 0.75 g/m2.

### White Pigment

The laser markable composition may comprise a white pigment. With such a composition, a white laser markable layer may be formed. The white background typically results in an enhanced contrast of the laser marked image. This may be particularly useful for laser marking barcodes or QR codes.

Such a white background may also be realised by applying a white primer before applying a transparent laser markable composition on top of the white primer.

The pigments described below may be used both in the laser markable composition or the primer.

The white pigment may be an inorganic or an organic pigment.

The white pigment may be selected from titanium oxide, barium sulfate, silicon oxide, aluminium oxide, magnesium oxide, calcium carbonate, kaolin, or talc.

A preferred white pigment is titanium oxide.

Titanium oxide occurs in the crystalline forms of anatase type, rutile type and brookite type. The anatase type has a relatively low density and is easily ground into fine particles, while the rutile type has a relatively high refractive index, exhibiting a high covering power. Either one of these is usable in this invention. It is preferred to make the most possible use of characteristics and to make selections according to the use thereof. The use of the anatase type having a low density and a small particle size can achieve superior dispersion stability, ink storage stability and ejectability. At least two different crystalline forms may be used in combination. The combined use of the anatase type and the rutile type which exhibits a high colouring power can reduce the total amount of titanium oxide, leading to improved storage stability and ejection performance of ink.

For surface treatment of the titanium oxide, an aqueous treatment or a gas phase treatment is applied, and an alumina-silica treating agent is usually employed. Untreated-, alumina treated- or alumina-silica treated-titanium oxide are employable.

The volume average particle size of the white pigment is preferably between 0.03 μm and 0.8 μm, more preferably between 0.15 μm and 0.5 μm. When the volume average particle size of the white pigment is within these preferred ranges, the reflection of light is sufficient to obtain a sufficiently dense white colour. The volume average particle size may be measured by a laser diffraction/scattering type particle size distribution analyzer.

However, a white background of the laser marked image resembles an image provided on a white label and/or may have an unwanted aesthetic effect on the total image. Therefore, the laser markable composition preferably does not include a white pigment. The laser markable composition is preferably transparent.

### Image-Receiving Layer for Thermal Printing

An image-receiving layer for thermal printing includes a colour forming agent capable of forming a colour upon exposure to heat. The colour forming agent is preferably a leuco dye.

The image-receiving layer for thermal printing and for IR laser marking preferably includes similar ingredients. However, an image-receiving layer for IR laser marking preferably includes an optothermal converting agent, which converts radiation into heat, while an image-receiving layer for thermal printing preferably typically does not include such an optothermal converting agent.

### Image-Receiving Layer for Laser Engraving

The image-receiving layer preferably has a colour that is different to the colour of the packaging box. Removal of the image-receiving layer then reveals text and/or images having the colour of the packaging box. Such a laser engraving process is disclosed in for example JP2013/208903.

When the image-receiving layer consists of a layer having a first colour covered by another layer having a second colour, then removing the top layer by laser engraving results in an image having the first colour on a background having the second colour. Such laser engraving process is disclosed in for example JP H10 138641.

Other preferred image-receiving layers for laser engraving are disclosed in for example EP-A 325639 (JT int.) and WO2020/008047 (Tetra Laval).

### Image-Receiving Layer for Inkjet Printing

Late stage customization with inkjet printing may be provided directly on the cardboard of the packaging box.

However, in a preferred embodiment, an image-receiving layer for inkjet printing is provided on the packaging box where late stage customization will be provided by inkjet printing. In this case, the image-receiving layer is also referred to as ink receiving layer. The image-receiving layer may include one or more layers.

The presence of the image-receiving layer allows to enhance the image quality of the inkjet printed image, especially when the inkjet inks are aqueous or solvent based inkjet inks. Also the adhesion of the inkjet inks on a substrate may be improved by using an ink receiving layer.

For environmental and safety reasons, the inkjet inks are preferably aqueous inkjet inks. The one or more ink receiving layers preferably include a hydrophilic polymer, such as a polyvinylalcohol, so that the aqueous medium of the aqueous inkjet ink is readily absorbed by the one or more ink receiving layers and the colour pigments are immobilized on the surface of the one or more ink receiving layers.

In a preferred embodiment, the one or more ink receiving layers include an ink receiving layer including a hydrophilic polymer H and an inorganic pigment P in a weight ratio of H:P≤1:3.

In a more preferred embodiment, the packaging material includes multiple ink receiving layers and an outermost ink receiving layer contains no inorganic pigment or an amount of inorganic pigment smaller than that of one or more ink receiving layers located between the packaging material and the outermost ink receiving layer. The advantage of having an outermost layer with no or a small amount of pigment is that the creation of dust is minimized resulting in an enhanced reliability of the inkjet printing process.

A particularly preferred ink-receiving layer contains a polyvinylalcohol and an inorganic pigment, preferably a silica-based pigment.

In a preferred embodiment, the ink-receiving layer includes a polymeric binder selected from the group consisting of hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulfate; polyvinyl alcohol; vinylalcohol copolymers; polyvinyl acetate; polyvinyl acetal; polyvinyl pyrrolidone; polyacrylamide; acrylamide/acrylic acid copolymer; polystyrene, styrene copolymers; acrylic or methacrylic polymers; styrene/acrylic copolymers; ethylene-vinylacetate copolymer; vinyl-methyl ether/maleic acid copolymer; poly(2-acrylamido-2-methyl propane sulfonic acid); poly(diethylene triamine-co-adipic acid); polyvinyl pyridine; polyvinyl imidazole; polyethylene imine epichlorohydrin modified; polyethylene imine ethoxylated; ether bond-containing polymers such as polyethylene oxide (PEO), polypropylene oxide (PPO), polyethylene glycol (PEG) and polyvinyl ether (PVE); polyurethane; melamine resins; gelatin; carrageenan; dextran; gum arabic; casein; pectin; albumin; chitins; chitosans; starch; collagen derivatives; collodion and agar-agar.

In a particularly preferred embodiment, the ink-receiving layer includes a polymeric binder, preferably a water soluble polymeric binder (>1 g/L water), which has a hydroxyl group as a hydrophilic structural unit, e.g. a polyvinyl alcohol.

A preferred polymer for the ink-receiving layer is a polyvinylalcohol (PVA), a vinylalcohol copolymer or a modified polyvinyl alcohol. The modified polyvinyl alcohol may be a cationic type polyvinyl alcohol, such as the cationic polyvinyl alcohol grades from Kuraray, such as POVAL C506, POVAL C118 from Nippon Goshei.

The pigment in the ink-receiving layer is an inorganic pigment, which can be chosen from neutral, anionic and cationic pigment types. Useful pigments include e.g. silica, talc, clay, hydrotalcite, kaolin, diatomaceous earth, calcium carbonate, magnesium carbonate, basic magnesium carbonate, aluminosilicate, aluminum trihydroxide, aluminum oxide (alumina), titanium oxide, zinc oxide, barium sulfate, calcium sulfate, zinc sulfide, satin white, alumina hydrate such as boehmite, zirconium oxide or mixed oxides.

In a preferred embodiment, (polymeric) cations in the ink-receiving layer are used in combination with aqueous inkjet inks containing anionic substances, such as an anionic polymeric dispersant. This results in “crashing” of the inkjet ink on the ink-receiving layer.

The inorganic pigment is preferably selected from the group consisting of alumina hydrates, aluminum oxides, aluminum hydroxides, aluminum silicates, and silicas.

Particularly preferred inorganic pigments are silica particles, colloidal silica, alumina particles and pseudo-boehmite, as they form better porous structures. When used herein, the particles may be primary particles directly used as they are, or they may form secondary particles. Preferably, the particles have an average primary particle diameter of 2 μm or less, and more preferably 200 nm or less.

In a preferred embodiment, the one or more ink-receiving layers have a total dry weight between 2.0 g/m² and 10.0 g/m², more preferably between 3.0 and 6.0 g/m².

### Inkjet Inks

Any type of inkjet ink, such as water-based inkjet inks, solvent-based inkjet inks, latex inkjet inks, oil-based inkjet inks, UV curable inkjet inks or hot melt inks.

Preferred inkjet inks are UV curable inkjet inks and water-based inkjet inks. An advantage of UV curable inkjet inks is their ability to adhere on different types of substrates without the necessity of using a primer. For health and safety reasons, for example at the packer, water based inkjet inks are however particularly preferred.

A typical composition of different types of inkjet inks is disclosed for example in “The Chemistry of Inkjet inks” edited by Shlomo Magdassi (ISBN 978981323495).

An inkjet ink typically contains a colorant, which may be a dye or a colour pigment. The inkjet inks are preferably pigmented inkjet inks as the use of colour pigments provide higher light stability than dyes.

An aqueous inkjet ink preferably includes at least a colour pigment and water, more preferably completed with one or more organic solvents such as humectants, and a dispersant if the colour pigment is not a self-dispersible colour pigment.

A UV curable inkjet ink preferably includes at least a colour pigment, a photoinitiator and a polymerizable compound, such as a monomer or oligomer. Preferred UV curable inkjet inks include a free radical polymerizable compound and a photoinitiator selected from the group consisting of an acylphosphine oxide compound, a thioxanthone compound and an α-hydroxy ketone compound. Such UV curable pigmented inkjet inks usually contain no water or solvent. The UV curable pigmented inkjet inks jetted on the packaging box are exposed to UV light shortly after the ink landed on the packaging material. The photoinitiator absorbs UV light and generates radicals that initiate a polymerization reaction of the free radical polymerizable compounds. In this manner, the jetted ink is ‘freezed’ on the packaging material due to a rapid increase of the ink viscosity caused by the polymerization reaction. UV curable pigmented inkjet inks allows for inkjet printing without one or more ink receiving layers being present.

However, one or more ink receiving layers are preferably present for improving image quality, when a substantial amount of the free radical polymerizable compound is replaced by water or organic solvents. The latter inks are addressed as hybrid UV curable inkjet inks, such as e.g. aqueous UV curable inkjet inks.

In another embodiment, a polyurethane or polyacrylate based latex binder is present in the one or more pigmented inkjet inks. When using aqueous inkjet inks this allows for the omission of the one or more ink receiving layers, as the latex binder binds the colorant to the packaging material. For aqueous UV curable pigmented inkjet inks, preferably the latex binder includes polymerizable groups, preferably (meth)acrylate groups, on the surface of the polymeric particles constituting the latex binder.

If multi-colour images are desired, the inkjet inks are composed into an inkjet ink set having differently coloured inkjet inks. The inkjet ink set is preferably a CMYK inkjet ink set. The inkjet ink set may be extended with extra inks such as white, brown, red, green, blue, and/or orange to further enlarge the colour gamut of the image. The inkjet ink set may also be extended by the combination of the full density inkjet inks with light density inkjet inks. The combination of dark and light colour inks and/or black and grey inks improves the image quality by providing a lowered graininess.

Preferred compositions of inkjet inks are disclosed in EP-A 19171083.9, paragraphs 102 to 160 (filed 25 Apr. 2019 by AGFA NV) and EP-A 19199525.7, paragraphs 0058 to 0122 (filed 25 Sep. 2019 by AGFA NV).

### Inkjet Printers

A preferred print head for the inkjet printer is a piezoelectric head. Piezoelectric inkjet printing is based on the movement of a piezoelectric ceramic transducer when a voltage is applied thereto. The application of a voltage changes the shape of the piezoelectric ceramic transducer in the print head creating a void, which is then filled with inkjet ink or liquid. When the voltage is again removed, the ceramic expands to its original shape, ejecting a drop of ink from the print head.

A preferred piezoelectric print head is a so called push mode type piezoelectric print head, which has a rather large piezo-element capable of ejecting also high viscous inkjet ink droplets. Such a print head is available from RICOH as the GEN5s print head.

A preferred piezoelectric print head is a so-called through-flow piezoelectric drop-on-demand print head. Such a print head is available from TOSHIBA TEC, as the CF1ou print head, and also from RICOH and XAAR. Through-flow print heads are preferred in the present invention, because they enhance the reliability of inkjet printing.

The inkjet print head normally scans back and forth in a transversal direction across the moving ink-receiver surface. Often the inkjet print head does not print on the way back. Bi-directional printing is preferred for obtaining a high areal throughput. Such an inkjet printer is called a multi-pass inkjet printer.

Another preferred printing method is by a “single pass printing process”, which can be performed by using page wide inkjet print heads or multiple staggered inkjet print heads that cover the entire width of the ink-receiving surface. In a single pass printing process, the inkjet print heads usually remain stationary and the ink-receiving surface is transported under the inkjet print heads.

When aqueous or solvent based inkjet inks are used, the inkjet printer includes a drying device to evaporate the water and solvents from the ink jetted on the packaging material. Suitable dryers include devices circulating hot air, ovens, and devices using air suction.

The drying device may include an infrared radiation source. An effective infrared radiation source has an emission maximum between 0.8 and 1.5 μm. Such an infrared radiation source is sometimes called a NIR radiation source or NIR dryer. NIR-radiation energy quickly enters into the depth of the inkjet ink layer and removes water and solvents out of the whole layer thickness, while conventional infrared and thermo-air energy predominantly is absorbed at the surface and slowly conducted into the ink layer, which results usually in a slower removal of water and solvents.

In a preferred embodiment, the NIR radiation source is in the form of NIR LEDs, which can be mounted easily on a shuttling system of a plurality of inkjet print heads in a multi-pass inkjet printers. Another preferred drying device uses Carbon Infrared Radiation (CIR).

When UV curable pigmented inkjet inks are used, the inkjet printer includes a UV curing device. The UV curing device emits UV radiation that is absorbed by the photoinitiator or photoinitiating system for polymerizing the polymerizable compounds of the core.

The UV curing device may include a high or low pressure mercury lamp, but preferably includes or consists of UV LEDs.

The UV curing device may be arranged in combination with the print head of the inkjet printer, travelling therewith so that the curing radiation is applied very shortly after jetting. Preferably such curing means consists of one or more UV LEDs, because in such an arrangement it can be difficult to provide other types of curing means that are small enough to be connected to and travelling with the print head. Alternatively, a static fixed radiation source may be employed, e.g. a source of curing UV-light, connected to the radiation source by means of flexible radiation conductive means, such as a fibre optic bundle or an internally reflective flexible tube, or by an arrangement of mirrors preferably including a mirror upon the print head.

However, it is not necessary to have the UV light source connected to the print head. The source of UV radiation may, for example, also be an elongated radiation source extending transversely across the ink on the packaging material to be cured. It may be adjacent to the transverse path of the print head so that subsequent rows of the decorative image formed by the print head are passed, stepwise or continually, beneath that radiation source.

Any ultraviolet light source, as long as part of the emitted light can be absorbed by the photoinitiator or photoinitiator system, may be employed as a radiation source, such as a high or low pressure mercury lamp, a cold cathode tube, a black light, an ultraviolet LED, an ultraviolet laser, and a flash light. Of these, the preferred source is one exhibiting a relatively long wavelength UV-contribution having a dominant wavelength of 300-400 nm, more preferably 360 to 400 nm. Specifically, a UV-A light source is preferred due to the reduced light scattering therewith resulting in more efficient interior curing.

UV radiation is generally classed as UV-A, UV-B, and UV-C as follows:
UV-A: 400 nm to 320 nm
UV-B: 320 nm to 290 nm
UV-C: 290 nm to 100 nm.

In a preferred embodiment, the inkjet printing device contains one or more UV LEDs with a wavelength larger than 360 nm, preferably one or more UV LEDs with a wavelength larger than 380 nm, and most preferably UV LEDs with a wavelength of about 395 nm.

Furthermore, it is possible to cure the image using, consecutively or simultaneously, two light sources of differing wavelength or illuminance. For example, the first UV-source can be selected to be rich in UV-C, in particular in the range of 260 nm-200 nm. The second UV-source can then be rich in UV-A, e.g. a gallium-doped lamp, or a different lamp high in both UV-A and UV-B. The use of two UV-sources has been found to have advantages e.g. a fast curing speed and a high curing degree.

For facilitating curing, the inkjet printing device often includes one or more oxygen depletion units. The oxygen depletion units place a blanket of nitrogen or other relatively inert gas (e.g. N₂ or CO₂), with adjustable position and adjustable inert gas concentration, in order to reduce the oxygen concentration in the curing environment. Residual oxygen levels are usually maintained as low as 200 ppm, but are generally in the range of 200 ppm to 1200 ppm.

In a particularly preferred embodiment, the inkjet printing of the pigmented inkjet inks is performed in a multi-pass printing mode. Multi-pass printing is a technique used to reduce banding in inkjet printing. Dots of ink, when still in liquid form, tend to run together due to surface tension. This is referred to as coalescence. To print a high quality image, it is important to print individual round dots. But to achieve full saturated colours, the dots must overlap to completely cover the substrate. By only printing a portion of the image data so as to avoid simultaneously printing adjacent dots during each printing cycle, coalescence may be largely avoided. Additionally, by avoiding all horizontal adjacencies, the transverse speed of the printing mechanism can be increased up to two times the rated print speed of the print head. In a preferred embodiment, the number of passes used is 2 to 6 passes, more preferably no more than 4 passes.

Another advantage of using a multi-pass printing mode is that the pigmented inkjet inks are cured in consecutive passes, rather than in a single pass requiring a drying or curing device with a high energy input. The print head lifetime is also larger for multi-pass printing. While in single pass printing one side shooter is sufficient to replace the whole print head, in multi-pass printing side shooters and even failings can be tolerated. Also the cost of a multi-pass printer is usually much lower, especially for wide format packaging materials.

### Cutting and Creasing

An apparatus provided with one or more operating stations configured to perform cutting and/or creasing on packaging material is well-known to the person skilled in packaging.

Recently, packaging machines have been developed to manufacture customized packaging boxes, so-called ‘box-on-demand’ systems. Such ‘box-on-demand’ packaging machines are exemplified by WO2016/203343 A (PANOTEC) and EP2697124 A (BOSCH).

The cutting may be performed by conventional means such as a die, but in the present invention preferably the cutting is performed by laser cutting. A laser is more flexible than conventional means for cutting packaging boxes of different sizes, resulting in a faster cutter process.

### Packaging Material

There is no restriction on the packaging material as long as it is suitable to manufacture a packaging box from it. Preferred packaging materials are low cost and lightweight. Lightweight packaging material reduces transportation costs and facilitates the handling during delivery to the customer.

A particular preferred packaging material is corrugated cardboard as it is low cost and lightweight, but also has the benefit that corrugated cardboard boxes are stackable, making them easy to store and transport.

Corrugated cardboard is a packaging material formed by gluing one or more fluted sheets of paperboard (corrugating medium) to one or more flat sheets (called facings) of linerboard. It comes in four common types: (1) Single face: one fluted sheet glued to one facing (total two sheets). (2) Single wall: one fluted sheet sandwiched between two facings (total three sheets); also called double face or single ply. (3) Double wall: one single-face glued to one single wall so that two fluted sheets are alternatively sandwiched between three flat sheets (total five sheets); also called double cushion or double ply. (4) Triple wall: two single-face glued to one single wall so that three fluted sheets are alternatively sandwiched between four flat sheets (total seven sheets); also called triple ply. The preferred corrugated cardboard in the present invention is single wall or double wall, more preferably single wall corrugated cardboard as this is sufficiently strong and easy to crease. Single face corrugated cardboard generally has insufficient strength to hold the merchandise articles, while triple wall cardboard is often more difficult to crease into a packaging box.

The strength of cardboard is important for deliverability, as if merchandise doesn't arrive intact in the hands of your customers, you risk your reputation with them.

The cardboard can come in a variety of constructions, such as e.g. honeycomb cardboard, however for easy creasing preferably a cardboard using a paper fluting medium is used.

The paper used in corrugated card board, such as Kraft paper, has often a brownish colour. In a preferred embodiment of the corrugated cardboard, the outer surface of the outer paper liner 11 (see FIG. 4) has a white colour for enhancing the colour vibrancy of the laser marked images thereon. The white colour background contributes to the customer experience as the customer regards this as a more luxurious product. Alternatively the white background may be realized, as described above, by using a white laser markable layer.

Another advantage of a paper based cardboard is the recyclability.

Any type of cardboard boxes may be used, such as the Postal box and the American folding box mentioned above. Preferred cardboard packaging boxes are the so-called slotted type boxes, consisting of one piece with a glued, stitched or taped manufacturer's joint and top and bottom flaps. These are shipped flat, ready to use and require closing using the flaps provided. There are several types of such slotted type boxes as discloses in the FEFCO Box Style Guide (category 02 Slotted Type Boxes).

However, for some merchandise it may be sensible to use corrugated plastic. Corrugated plastic is a waterproof, versatile material that can be die cut in the same way as corrugated cardboard. Light weight and durable, this material also has a longer shelf life than cardboard and is better at holding out moisture, such as snow and rain.

1-15. (canceled)

16. A method of preparing a packaging box, wherein late stage customization is provided on the inside of the packaging box.

17. The method according to claim 16, the method including the steps of:
selecting an unfolded packaging box;
providing late stage customization on those parts of the unfolded packaging box that will form the inside of a packaging box;
folding the unfolded packaging box provided with the late stage customization to obtain the packaging box;
filling the packaging box with one or more purchased articles; and
closing the filled packaging box.

18. The method according to claim 16, the method including the steps of:
selecting an unfolded packaging box;
folding the selected unfolded packaging box to obtain a packaging box;
providing late stage customized information on the inside of the packaging box before, during, or after filling the packaging box with one or more purchased articles; and
closing the filled packaging box.

19. The method according to claim 17, wherein a time between providing late stage customization and filling the packaging box with one or more purchased articles is less than 12 hours.

20. The method according to claim 18, wherein a time between providing late stage customization and filling the packaging box with one or more purchased articles is less than 12 hours.

21. The method according to claim 17, wherein the packaging box includes one or more top flaps and wherein late stage customization is provided on the inside of at least one top flap.

22. The method according to claim 18, wherein the packaging box includes one or more top flaps and wherein late stage customization is provided on the inside of at least one top flap.

23. The method according to claim 17, wherein the unfolded packaging box is selected according to a minimal packaging box dimension, the minimal packaging box dimension determined based on outer dimension of one or more purchased articles.

24. The method according to claim 18, wherein the unfolded packaging box is selected according to a minimal packaging box dimension, the minimal packaging box dimension determined based on outer dimension of one or more purchased articles.

25. The method according to claim 23, wherein late stage customization is provided taking into account the minimal packaging box dimension.

26. The method according to claim 24, wherein late stage customization is provided taking into account the minimal packaging box dimension.

27. The method according to claim 16, wherein late stage customization is provided by an imaging technique selected from the group consisting of laser marking, laser engraving, thermal printing, and inkjet printing.

28. The method according to claim 27, wherein the unfolded packaging box comprises an image-receiving layer adapted for the imaging technique used to provide late stage customization.

29. The method according to claim 16, wherein late stage customization includes customer information on buying intentions of the customer who purchased the one or more articles.

30. The method according to claim 29, wherein the customer information is derived from the browser history of the customer at an online seller's website where the one or more articles are purchased.

31. The method according to claim 1, wherein the image includes personalized information of the customer who purchased the one or more articles.

32. The method according to claim 31, wherein the personalized information is derived from the interaction of the customer at an online seller's website where the one or more articles are purchased.

33. The method according to claim 16, wherein the packaging box is made from corrugated cardboard.

34. The method according to claim 16, wherein the late stage customization is used for personalized advertisement.
